(19) United States
(12) Patent Application Publication
(10) Pub. No.: US 2006/0191425 A1
(43) Pub. Date: Aug. 31, 2006

(54) Pulp squeezer

(76) Inventor: Ming-Shih Chang, Taipei (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 11/410,907

(22) Filed: Apr. 26, 2006

Related U.S. Application Data
(63) Continuation-in-part of application No. 10/946,551, filed on Sep. 22, 2004.

(51) Int. Cl. A23N 1/00

(52) U.S. Cl. 99/511

(57) ABSTRACT

A squeezer can be used to produce a pulp contained juice instead of the conventional squeezer only provided juice. The squeezer comprises a motor base, a rotary disk, a bowl, a cutter disk, a mask, an upper lid and a feed tube passed through a receiving opening of the upper lid. In which, a circular lid is introduced between the bottom end of a receiving opening and the cutter disk. The cutter disk has a ring type press plate relative to the cutter disk in an up and down relationship. A gap kept between the ring type plate and the cutter disk allows shredded fruits to be macerated to form pulp contained juice and then drained out. The mask is composed of a support frame and a watertight base. Because the mask has no meshes, the pulp contained juice can be led into the bowl.

### CROSS REFERENCE TO RELATED APPLICATION

The present invention is a C-I-P application related to the application assigned Ser. No. 10/946,551 published on Mar. 23, 2006.

### FIELD OF THE INVENTION

The present invention is related to a pulp squeezer, particularly to a squeezer can be used to extract pulp contained juice from fruit or vegetable.

### GROUND OF THE INVENTION

As shown in FIGS. 1 and 2, a conventional squeezer 10 comprising: a base 1 is served as a housing for a motor 11, a rotary disk 2 coupled to a shaft 21 of the motor 11, a bowl 3 mounted on the base 1, a cutter disk 4 with a base 41 further coupled to the shaft 21 by screwing, a strainer 5 introduced between the cutter disk 4 and the bowl 3, therefore, the strainer 5 inside the bowl are held in assembled relation to the rotary disk 2 by screwing the blade disk 4 once for all, an upper lid 6 capped the bowl 3, and the upper lid 6 having a receiving opening 61 for receiving a feed tube 7.

As shown in FIG. 3, a cross sectional view of the conventional squeezer is illustrated. It depicts that shredded fruits 8 first put in the central bore 61, and then pressed downward by the feed tube 7, the shredded fruits 8 can be ground to juice by running the cutter disk 4 at high speed and to impel the pulp 81 along the tangent line dropped into the strainer 5. Because the strainer 5 is rotating with the rotary disk 2 simultaneously, juice 82 can be separated from the pulp 81 through screen 51 of the filter strainer 5 by centrifugal force. After falling through the bowl 3, the juice 82 flow through a discharging opening 63 into the container 40. At present time, most fruit and vegetable are still squeezed to extract juice likely in this way.

Said squeezer 10 can be used to extract juice from the fruit, but after squeezing only debris left. To squeeze fruit or vegetable, the conventional squeezer usually is not designed to retain a pulp contained juice and fibers. Though the pulp received less filtration is popular to serve as healthy foodstuff such as the alternative fruit sweetener to smear pieces of toast, fresh ingredients added to the fruit pie, cake decoration, appetizer, even nutrition supplements for the patients and children. However, restricted to the conventional squeezer could not produce the pulp as desired, in other words, the users hardly get pulp simply by DIY.

As a result, persons skilled in art have provided squeezers to assist the users to squeeze a fruit or vegetable.

In U.S. Pat. No. 2,228,822, Heinrich taught that a feed tube slightly spaced from shredder plate, which has its top surface roughened for shredding the fruit resting there against the tube, after juicing, pulp collecting on the side wall, which is not perforated, of the pan. Upward movement of the particles (or pulp) pack under the overhanging rim, as the pan revolves the pipe will scoop up the particles and they will pass through the pipe to the outer end thereof. A suitable container can be placed under the outer end of the pipe to collect the dry pulp.

In U.S. Pat. No. 2,273,093, Drachenberg taught that the disk (41) is rotated, the blades (43,44) macerate and grind the fruit assisted by the blades (52,53) and sharp edges of he grooves (42). The macerated pulp is thrown outwardly against the perforated wall (37) of the strainer and the juice extracted therefrom in order that there may be a maximum amount of juice.

In U.S. Pat. No. 2,311,379, Maxwell taught that through centrifugal force and gravity, pulp strained out juice by rapidly rotating screen, then the pulp being discharged from the slots and caught by the blade, pulp become shorter in length but larger in cross sectional dimension; the pulp has an ever increasing tendency to be thrown off tangently; centrifugal action causes maximum juice extraction, so that the pulp issuing from the chute is relatively dry.

In U.S. Pat. No. 2,369,406, Albert taught that juice extractor are required to operate at relatively high speed about 10,000 revolutions per minute in order to obtain sufficient centrifugal force., '406 simplify the support and alignment structures of drive and driven parts for high speed rotation.

In U.S. Pat. No. 2,481,010, Gundelfinger William taught that an annular pulp receiving trough is provided having a bottom wall (68) and inner and outer wall (70,72) that results from the centrifugal force discharge juice through very minute perforations on the basket to prevent the pulp from passing therethrough, instead the pulp retained in the basket become drier. The pulp finally discharges into the annular pulp receiving trough. It is necessary to empty the pulp from the machine.

In U.S. Pat. No. 2,527,695, John taught that when juicing, fibrous particles retained between the stationary member and the rotating disk; then the fibrous particles built upon the basket retained by ring (71) until it is whirled around completely dry of juice. But juice passing through the foraminuos basket (27), the casing (36) carries a collecting ring with a spout (40) through which the juice is drained.

In U.S. Pat. No. 2,590,237, Doering William taught that a juice extractor can be applied to extract juice from both vegetables and fruits, slots (21) formed with a wing on the leading edge and a row of teeth along the trailing edge, in rotation, the top of the teeth first past through a fixed plane through the axis of rotation; the wing can prevent centrifugal force from throwing particles formed by the teeth, in the lower part of the reamer several outlet passages thru which particles entering the reamer thru slots are discharged by centrifugal force into the strainer. Thereby, a kind of fruit or vegetable which is brought into contact with the reamer can be quickly disintergrated to fine pulp from which the juice is quickly removed in the strainer.

In U.S. Pat. No. 4,183,293,Arao et al. taught that a scraper (29) is detachably and deflectably pivoted on a frame (27) formed integrally with a food pressing member (18), a grating gap A is shaped between the pressing member and a cutting plate (12), and a spring (36) provided to push the scraper tip to scrap on the perforations (11) of the peripheral wall (8′), which are larger than those of the filter. As a result, fine pulp passed the filter mixed with the juice, tips of ground pulp are inserted into the peripheral wall by centrifugal force cut by the scraper and then ground into fine pulp when passing the perforations (11), hard pulp are not caught by the filter.

In U.S. Pat. No. 4,681,031, John taught that the screen has a mesh size 0.025 inch in diameter, pulp will move across the screen more time to extract juice; 16 cutter ridges (92a,92b) equally spaced about plate (88), in which, the first 8 ridges (92a) starting adjacent to the central hole, the second 8 ridges (92b) positioned in between ridges (92a) extend tangential to the central hole, improves juice extraction 25˜30% and distribution of pulp about the screen. Cutter plate (98) above the plate (88) interacts with the ridges to macerate the raw material, the periphery of the plate (98) extends an arc length about 270 degrees, so that the pulp must travel over the ridges before it can be expelled out onto the screen to improve juice output and pulverize the raw stock material.

In U.S. Pat. No. 5,031,522, Brixel et al. taught that during centrifugation process, a separation of the mash M into the solid phase (17), fibrous components F, liquid phase (18), and raw juice R., shearing friction acting through sieve screen openings (15 ) causes gas combined pectin contained in the liquid phase to form a foam (19). Carbon dioxide can be conducted thru openings (11) of a guiding frustoconical member 10 inside the sieve (9) to impair the product quality by germination. The foam is mechanically separated in a downstream vibrating sieve screen (23). A residual cellulose fiber fraction I in a first centrifugal decanter, the fibrous material F separated into cellulose fiber fraction II, both of them are depectinized.

In U.S. Pat. No. 5,417,152, Harrison Robert taught that a safety interlock keeps the extractor motor from being energized unless a juice bowl first locked to its base and the juice bowl cover is then locked to the juice bowl. A juice extractor with motor control, juice can be most efficiently extracted from comestibles operating at selected constant speed (Hi/ Lo/Stop). Juice expressed thru holes 36 in filter 34, collected in a sump then flowed thru outlet into spout to the container, the pulp cannot pass through filter holes 36 and is expelled by the rotation of basket 16 over the top of this basket and through a pulp chute 44 into pulp container 46.

In U.S. Pat. No. 5,495,795, Harrison Robert et al. also taught that the motor only allowed to operate when interlock column segments (56,58,60) are properly aligned by locking the juice bowl to the base and cover to the juice bowl. Upper edge (79 ) trapped in recess (170) between the two flange segments (174) and flange (176), locking cover (18) to juice bowl (14). Fingers (184a-d) take up any slack between cover (18) and juice bowl (14), producing a tight, leak-inhibiting fit between the juice bowl and its cover. Therefore, capillary leakage of collected juice between cover and juice bowl can be eliminated, and the extractor can be safely operated.

In U.S. Pat. No. 5,924,357, Chen taught that the tapered baffle (164) adjacent to the tapered wall of the strainer hood (14), and the bottom baffle (165) adjacent to the cutter blades (152) of the cutter disk (15) are used to limit the movement space of the residual dregs of the fruits and vegetables, thereby largely lengthening the contact time of the residual dregs with the cutter blades (152) of the cutter disk (15) and the meshes (142) of the strainer hood (14) so as to extract more juices from the residual dregs of the fruits and vegetables, thereby efficiently increasing the juice extracting and straining effect to the fruits and vegetables.

### SUMMARY OF THE INVENTION

The present invention is to provide a pulp squeezer comprising a base having a motor mounted therein, a rotary disk assembled to a shaft of the motor, a bowl assembled to the base to isolate a cutter disk, which is also assembled to the shaft of the motor, a mask without meshes secured to the rotary disk through the cutter disk, an upper lid capped over the bowl, and a feed tube received into the receiving opening of the upper lid characterized in that:

a circular lid assembled to a bottom side of the receiving opening; a ring-type horizontal press plate extending from the circular lid; the ring-type horizontal plate corresponds to the cutter disk in an up and down relationship; a small gap kept between the horizontal press plate and the cutter disk allows the shredded fruits to be macerated as a pulp contained juice and then drained out.

According to aforesaid pulp squeezer, said circular lid has a ring shaped press plate further extended downward with a wall spaced a gap from the cutter disk.

According to aforesaid pulp squeezer, said circular lid having a flange projected inward along its central bore to adapt to a bottom side of the receiving opening fit into.

According to aforesaid pulp squeezer, said circular lid formed with the bottom side of the feed tube integrally as a whole.

According to aforesaid pulp squeezer, said circular lid equipped with a plastic button embedded into a trough on the receiving opening, the central bore of the circular lid equipped with a tenon vertically led into a trough on the receiving opening.

According to aforesaid pulp squeezer, a mask without meshes consists of a support frame and a watertight base.

According to aforesaid pulp squeezer, a V shape cutter disposed at a center of the cutter disk, two edges converged at an acute angle to form a V shape.

According to aforesaid pulp squeezer, a baffle disposed above a discharging opening of the bowl, the baffle comprises a push key, the push key connects to a pair of sliding plate, one is a net plate, but the other is a sealed plate.

According to aforesaid pulp squeezer, a cambered trough formed on the motor base, a rotated button switch added to the wall of the bowl, the switch is relative to the cambered trough of the base, furthermore, the switch is a rotated bolt transversally inserted into a bolt hole on the bowl, the rotated bolt has a hole relative to a discharging opening at a bottom of the bowl.

### EFFECT AND FUNCTION

After the circular lid assembled to the feed tube of the upper lid, the shredded fruit can be macerated between circular lid and cutter disk, because a gap kept between them, the shredded fruit can be macerated to form pulp contained juice.

The mask is not formed with meshes, the pulp contained juice can be led into the bowl through the mask, further, V shaped cutter at a center of the cutter disk can be used to eliminate dead space thereof, the baffle and the rotated button can be used to control whether the pulp contained juice flowed out or not.

### BRIEF DESCRIPTION OF THE DRAWINGS

FIG. 1: shows an assembled view of a conventional squeezer;

FIG. 2: shows an exploded view of a conventional squeezer;

FIG. 3: shows a cross sectional view of a conventional squeezer;

FIG. 4: shows an exploded view of the first embodiment of the squeezer of the present invention;

FIG. 5: shows an assembled view of the first embodiment of the squeezer of the present invention;

FIG. 6: shows a schematic view of the circular lid adapted to a cutter disk;

FIG. 7: shows an alternative schematic view of the circular lid adapted to a cutter disk;

FIG. 8: shows an exploded view of the circular lid adapted to a bottom end of the receiving opening;

FIG. 9: shows a cross sectional view of a circular lid assembled to a bottom end of a receiving opening;

FIG. 10: shows a top plan view of the cutter disk;

FIG. 11: shows a cross sectional view of a squeezer;

FIG. 12: shows a schematic view of the upper lid of the second embodiment;

FIG. 13: shows an assembled view of the squeezer of the third embodiment; and

FIG. 14: shows a cross sectional view of FIG. 13.

### DETAILED DESCRIPTION OF THE PREFERRED EMBODIMENTS

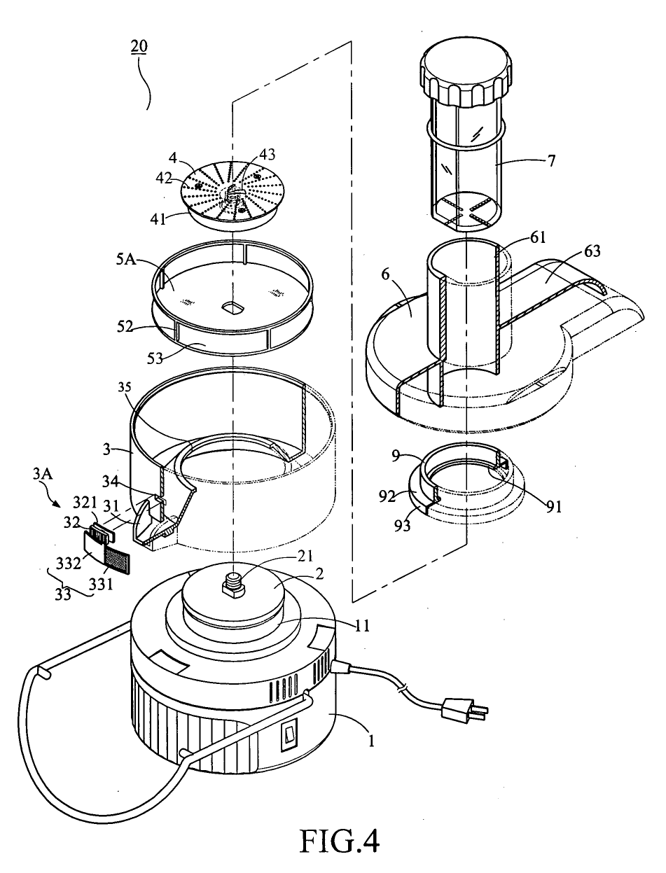

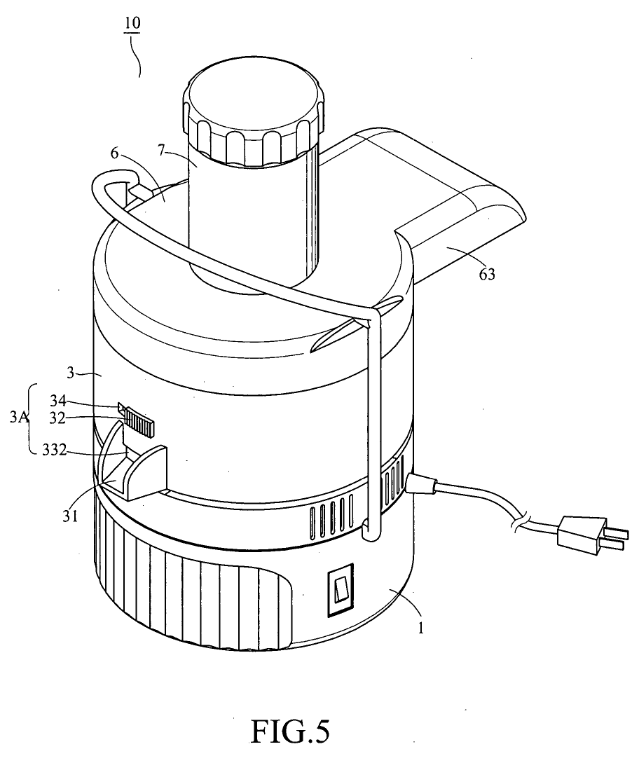

As shown in FIG. 4, a first embodiment of the present invention is illustrated. In that, a squeezer 20 includes a base 1 having motor mounted inside thereof, a rotary disk 2, a bowl 3, a cutter disk 4, a mask 5A, an upper lid 6 and a feed tube 7; a circular lid 9 is further introduced between a bottom end of the receiving opening and the cutter disk. After assemblage, the semblance of the assembled squeezer is illustrated as the FIG. 5 shown.

In FIG. 5, a circumference of the upper lid is formed with a discharging opening 63 for draining out fruit dregs. But the discharging opening can be omitted for producing a pulp contained juice. Furthermore, a baffle 3A can be formed on a wall of the bowl 3, this baffle can also be omitted for scooping out pulp contained juice accumulated in the squeezer with scoop by removing the upper lid.

The present invention is accentuated by a circular lid 9, which is assembled to a bottom side of the receiving opening 61 of the upper lid 6.

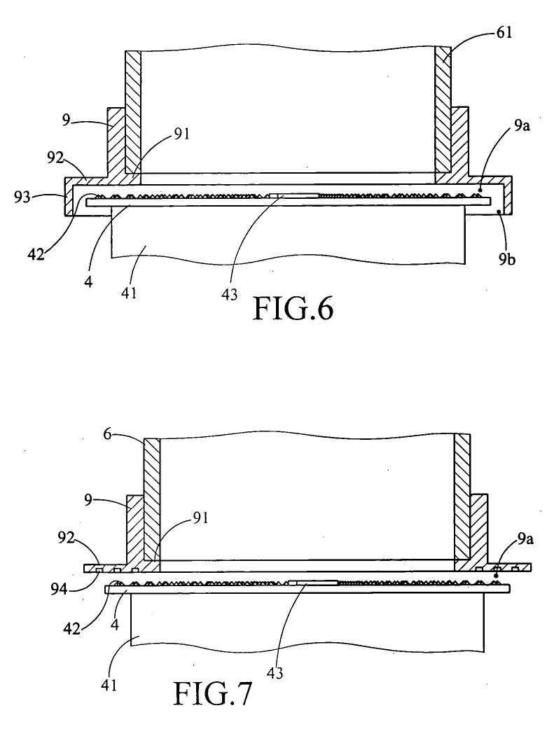

As shown in FIG. 6, a circular lid 9 fits over a bottom end of the receiving opening 61, the circular lid 9 further has a central bore with a flange extended inwardly, the flange can be used to adapt to the bottom side of the receiving opening 61 fit into. Thus, the circular lid 9 can be assembled to the bottom side of the receiving opening integrally and promptly. Moreover, the circular lid has a ring type press plate 92 extended horizontally from the central bore to cover, at least, to a circumference of the cutter disk in an up and down relationship. A circumference of the ring type press plate 92 is preferrably equal to or larger than a circumference of the cutter disk 4. A small gap 9a kept between the circular lid and the cutter disk.

Furthermore, a wall 93 can be extended downward vertically from the circumference of the circular lid to cap over the cutter disk 4, and this extended downward wall 93 is spaced a small gap 9b to a rim of the cutter disk 4. Therefore, when grinding, pulp contained juice can flow along the gap 9b, at the same time, the wall 93 extended downward can further dampen the ground pulp and delay duration of grinding.

As shown in FIG. 7, a circular lid 9 is not equipped with a wall 93 as depicted in FIG. 6. But the shredded fruit can be macerated to produce pulp contained juice between the ring type plate 92 and the cutter disk 4. Next, a second face of the ring type plate 92 faced away the receiving opening can be shaped with circular grooves 94, these grooves can be arrayed in the shape of whirlpool or spaced equidistantly to facilitate pulp contained juice flow out.

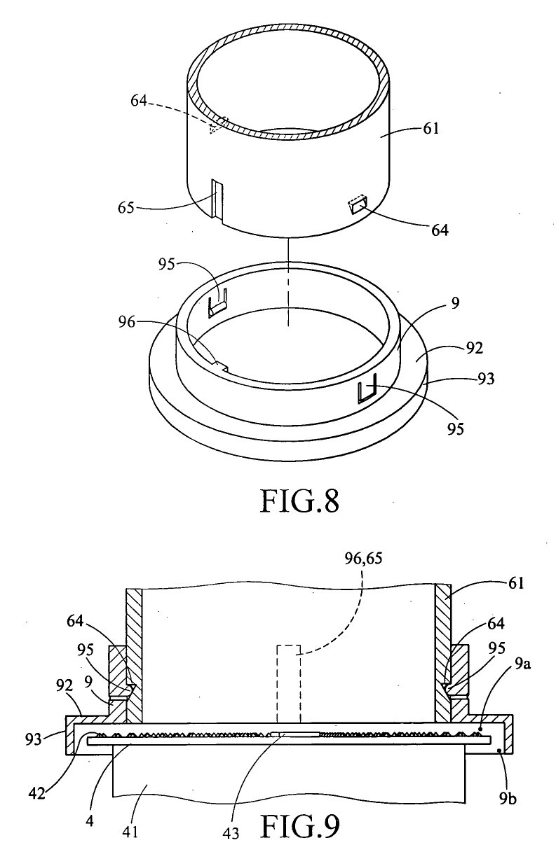

As shown in FIG. 8, a circular lid 9 is assembled to the receiving opening 61 different from the foregoing ways. Put emphasis on two plastic buttons 95 exposed out of the circular lid 9 relative to two corresponding troughs 64 formed along a rim of the receiving opening 61. In addition, a vertical tenon 96 disposed inside the central bore of the circular lid 9, while a vertical trough 65 formed on a wall of the receiving opening 61, the tenon 96 can be led into the trough 65 to eliminate rotated movements between the circular lid and the receiving opening.

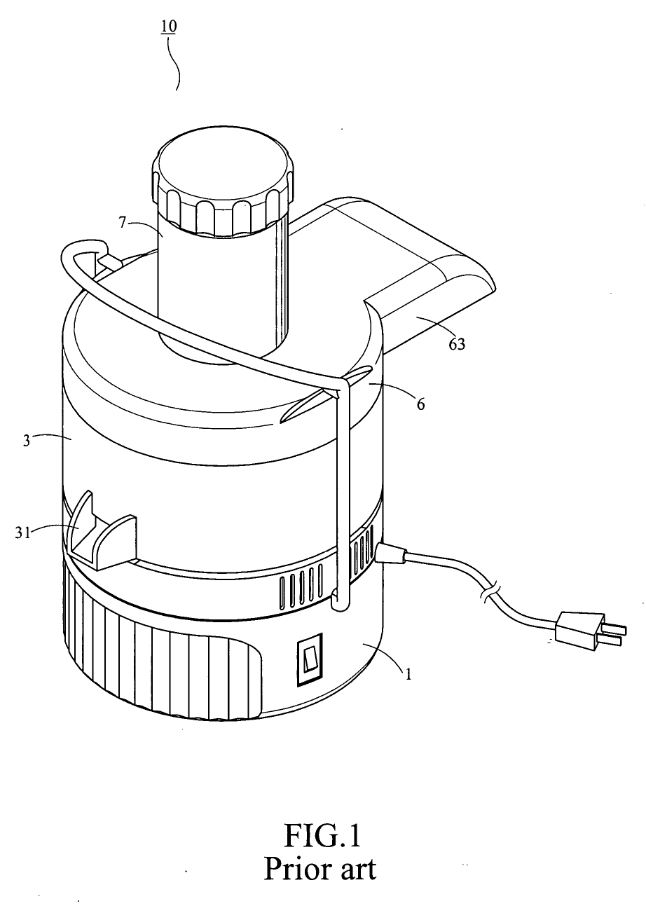

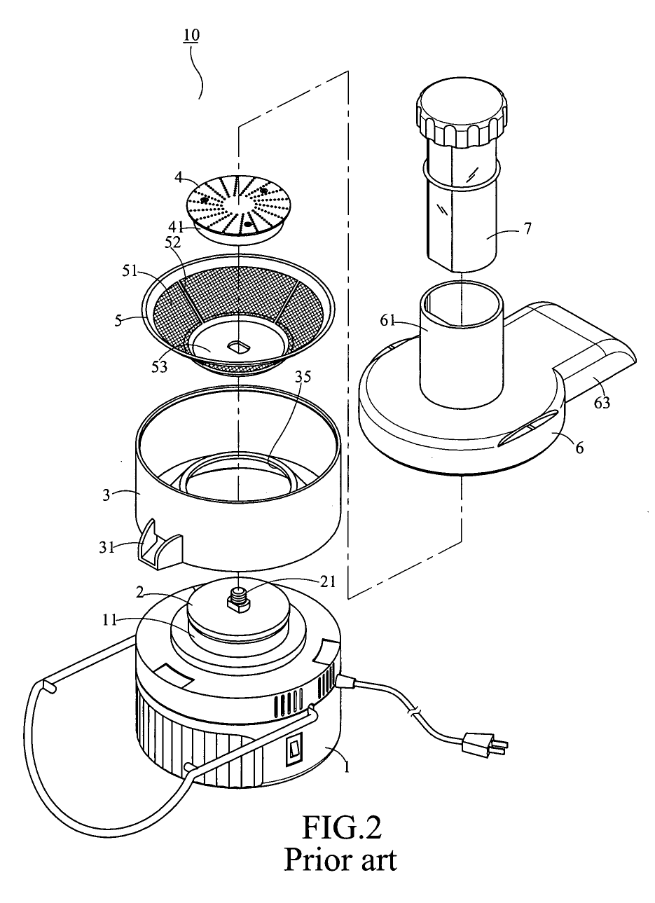

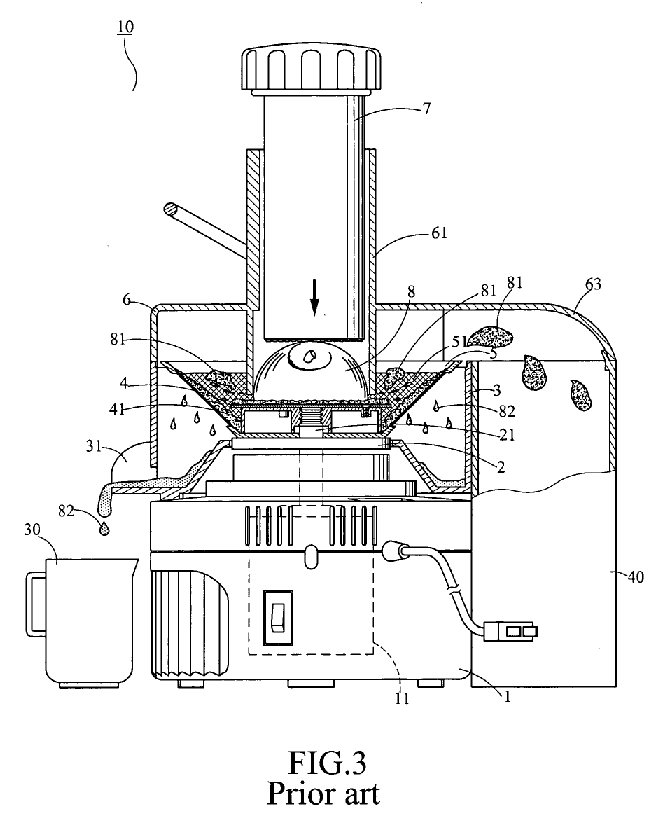

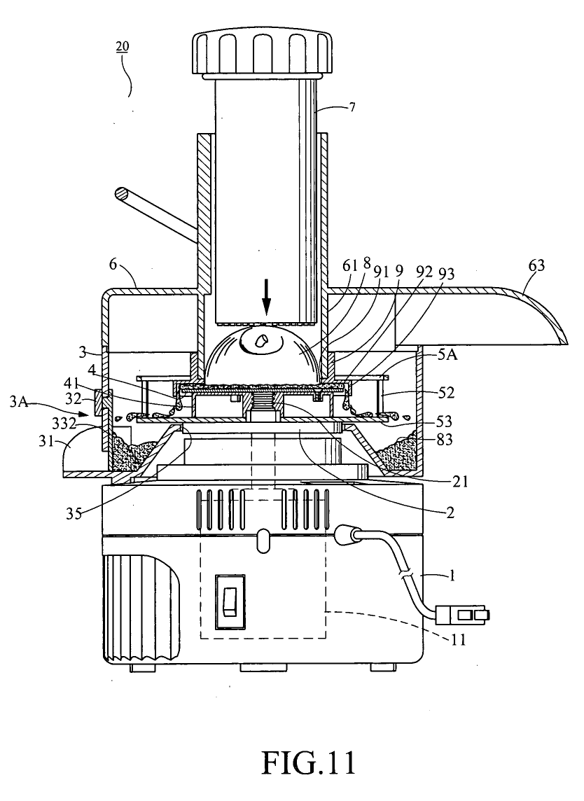

Once the circular lid 9 assembled to the receiving opening according to foregoing three methods, a conventional strainer 5 formed with meshes 51 must be changed into a mask 5A only equipped with a support frame 52 and a watertight base 53 (illustrated as in FIG. 4). In other words, the meshes 51 are excluded from the mask 5A. Furthermore, a height of the mask 5A can be lowered due to a funnel like device can be omitted in between. In addition, the base 53 is applied to prevent the pulp contained juice from draining out through a central bore 35 of the bowl 3. (Please also see FIG. 1) Owing to the mask 5A is not formed with meshes, therefore, a produce of pulp contained juice (as illustrated in FIG. 11) directly flows into the bowl 3 by centrifugal activity.

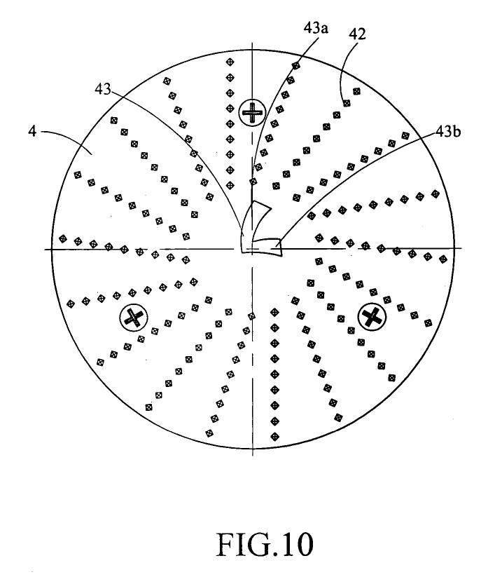

Furthermore, as shown in FIG. 10, a cutter disk 4 differentiates from a conventional cutter disk, which can be configured by a plurality of cutters 42 distributed radially on a first surface of the cutter disk faced the receiving opening, each cutter 42 consists of a number of tips aligned in serial connection. However, a center of the conventional cutter disk is a dead space without any tips. Therefore, the cutter disk 4 configured by a central V shaped cutter 43 converged by two cambered edges, one edge 43a is longer than the other edge 43b, and each edge has a sharpened leading edge but a trailing edge connected to the cutter disk 4.

Because the convergent V shape cutter added to a center of the cutter disk, the central dead space of the conventional cutter disk can be eliminated as well. A longer and a shorter edges 43a, 43b are converged at an acute angle to form a V shape can be applied together to chop the fibers at different length respectively. V shaped converged cutter can be formed on the cutter disk only required one step by punching at ease.

In addition, a baffle 3A can be added to a discharging opening 31 of the bowl 3, as shown in FIG. 4, a push key 32 disposed inside a slide trough 34 above the discharging opening 31 of the bowl 3, a closed plate 321 disposed behind the push key 32 is connected to a pair of sliding plates 33, which consists of a net plate 331 as a right side plate, and a sealed plate 332 as a left side plate. When the push key 32 is moved leftward or rightward, the pair of plates 33 will be carried together to move leftward or rightward simultaneously. When the net plate 331 is moved to the discharging opening 31 (as illustrated in FIG. 11), the pulp contained juice can flow out, while the sealed plate 332 is moved into the discharging opening 31, the pulp contained juice will not flow out. The pulp 83 contained juice first can be accumulated fully into the bowl 3, and then take away the upper lid to scoop out the pulp contained juice by spoon. If the baffle 3A is not installed to the bowl, all of the pulp contained juice will only flow out of the discharging opening 31.

### Second Embodiment

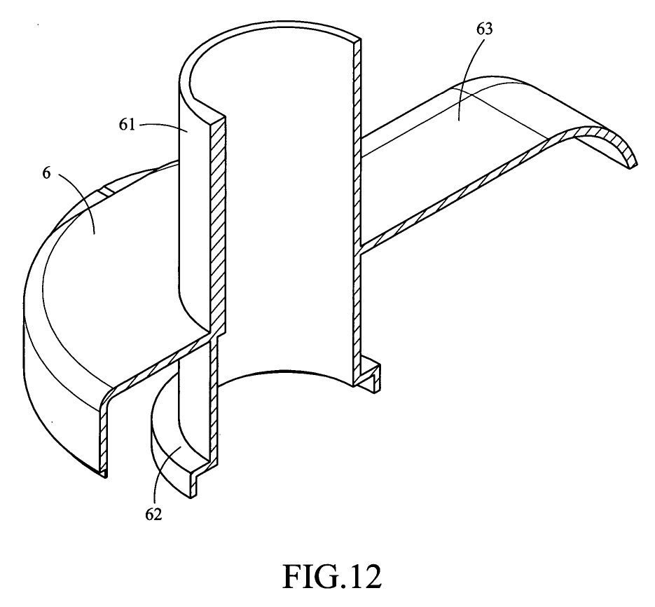

As shown in FIG. 12, an upper lid 6 of the second embodiment is illustrated, in which, a circular lid 62 is disposed to the bottom side of the receiving opening 61 of the upper lid 6. The circular lid 62 is formed with the receiving opening 61 integrally as a whole; the circular lid 62 has the same structure as the circular lid 9 depicted in FIG. 6, but the circular lid 62 assembled to the feed tube in a different way. And the circular lid 62 can be applied to the squeezer only to produce pulp contained juice.

### Third Embodiment

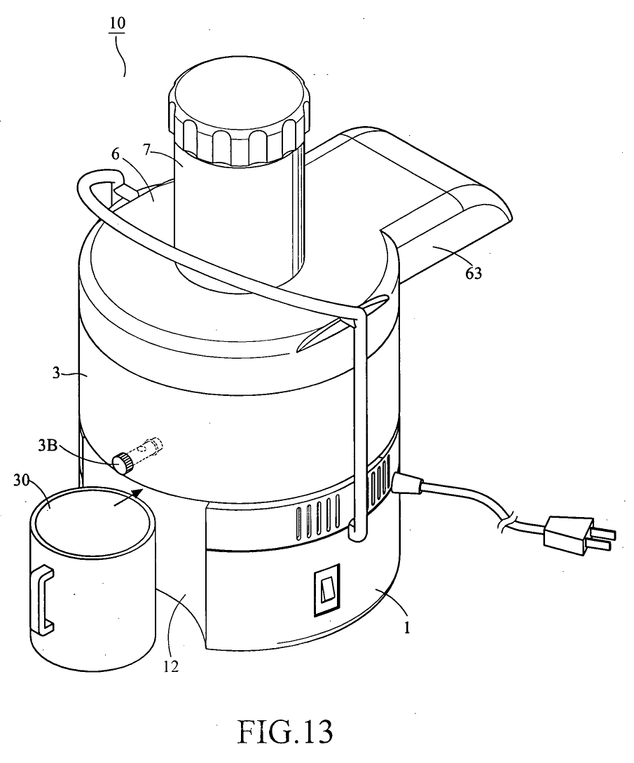

As shown in FIG. 13, an assembled view of the third embodiment is illustrated. But the third embodiment differentiates from the first embodiment as a wall of the bowl 3 is not formed with a discharging opening, in addition, a concaved recess 12 is formed on a wall of the motor base 1, and a rotation switch 3B is added to the wall of the bowl 3. The rotation switch 3B is a rotated bolt 36 first transversally inserted to a bolt hole of the bowl 3 and then fixed by a clamp ring 38. Because the rotated bolt 36 has a hole 361 (a filter net 362 installed inside the hole 361), which is relative to a discharging opening 37 formed through a bottom of the bowl 3, therefore, the pulp contained juice can flow out through the discharging opening 37 and the hole 361 of the rotated bolt 36. On the other hand, as the rotated bolt 36 is rotated at a right angle, the hole 361 is not in alignment with the discharging opening 37, the pulp contained juice will not flow out.

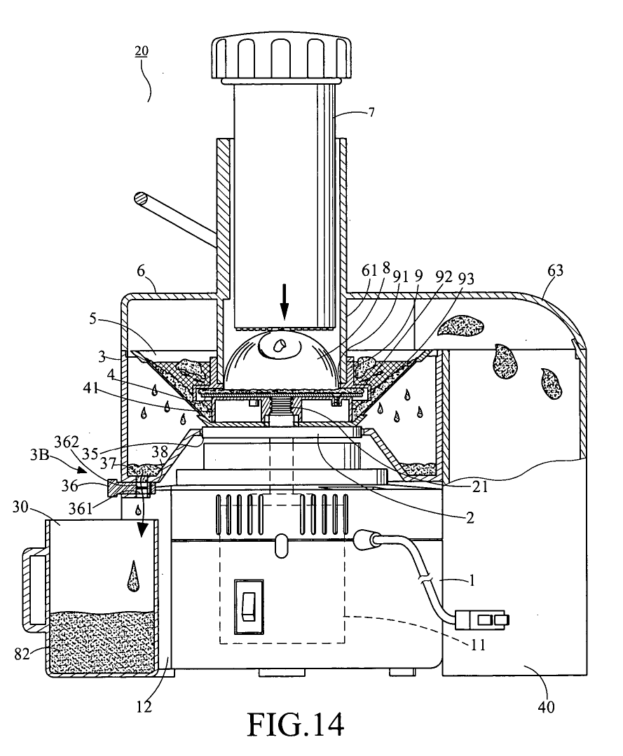

The third embodiment can be assembled to a conventional squeezer as depicted in FIG. 14, a cross sectional view of the rotation switch 3B in practice in the conventional squeezer 20.

What is we claimed:

1. A pulp squeezer comprising a base having a motor mounted therein, a rotary disk assembled to a shaft of the motor, a bowl assembled to the base to isolate a cutter disk, which is also assembled to the shaft of the motor, a mask secured to the rotary disk by the cutter disk, an upper lid capped over the bowl, and a feed tube received into the receiving opening of the upper lid characterized in that:
a circular lid assembled to a bottom side of the receiving opening; a ring-type horizontal press plate extending from a central bore of the circular lid; the ring-type horizontal plate corresponds to the cutter disk in an up and down relationship; a small gap kept between the horizontal press plate and the cutter disk allows the shredded fruits to be macerated as a pulp contained juice and then drained out.

2. A pulp squeezer according to claim 1 wherein said circular lid has a ring type plate further extended downward with a wall spaced a gap from the cutter disk.

3. A pulp squeezer according to claim 1 wherein said circular lid having a flange projected inward inside a central bore for adapting to a bottom side of the receiving opening to fit into.

4. A pulp squeezer according to claim 1 wherein said circular lid formed with the bottom side of the feed tube integrally as a whole.

5. A pulp squeezer according to claim 1 wherein said circular lid equipped with a plastic button embedded into a trough on the receiving opening, the central bore of the circular lid equipped with a tenon vertically led into a trough on the receiving opening.

6. A pulp squeezer according to claim 1 wherein a mask consists of a frame and a watertight base.

7. A pulp squeezer according to claim 1 wherein a V shaped cutter disposed on a first surface of the cutter disk opposite to the receiving opening, two edges converged at an acute angle to form a V shape.

8. A pulp squeezer according to claim 1 wherein a baffle disposed above a discharging opening of the bowl, the baffle comprises a push key, the push key connects to a pair of sliding plate, one is a net plate, the other is a sealed plate.

9. A pulp squeezer according to claim 1 wherein a cambered trough formed on the base, a rotated button switch added to a wall of the bowl, the switch is relative to the cambered trough of the base, furthermore, the switch is a rotated bolt transversally inserted into a bolt hole on the bowl, the rotated bolt has a hole relative to a discharging opening on the bottom of the bowl.
